(19) United States
(12) Patent Application Publication
(10) Pub. No.: US 2017/0129233 A1
(43) Pub. Date: May 11, 2017

(54) APPARATUS AND METHOD FOR LAMINATION

(71) Applicants: Nicolaas Jan BOLLEMAN, Axel, Zeeland (NL); ELOPAK a.s., Spikkestad (NO)

(72) Inventor: Nicolaas Jan Bolleman, Axel (NL)

(21) Appl. No.: 15/318,848

(22) PCT Filed: Jun. 19, 2015
(86) PCT No.: PCT/GB2015/000190

§ 371 Date: Dec. 14, 2016

(30) Foreign Application Priority Data
Jun. 19, 2014 (GB) 1410964.9

(51) Int. Cl. B32B 37/15; B32B 27/10; B32B 15/085; B32B 37/00; B32B 15/20

(52) U.S. Cl. CPC B32B 37/153; B32B 37/0053; B32B 15/20; B32B 15/085; B32B 27/10; B32B 2323/046; B32B 2553/00

(57) ABSTRACT

A laminating station comprises a chill roll (8), a press roll (4) parallel to the chill roll (8), a back-up roll (10) for biasing the press roll (4) towards the chill roll (8), an extrusion arrangement which serves to deposit a layer entering a nip between the rolls (4) and (8), a belt-guiding arrangement (14,16) extending parallelly to the roll (4), leftmost and rightmost endless belts (12) extending over the roll (4) and the belt guiding arrangement (14,16) and through the nip, and, between the leftmost and rightmost endless belts (12), intermediate endless belts (24) extending over the roll (4) and the belt guiding arrangement (14,16) and through the nip. The belts (12) serve to deter contact, with the press roll (4), of the layer being deposited. The belts (14) and (16) have that function and/or the function of pressing an outer tie layer of the laminate being produced into holes through a core layer of the laminate and so into contact with an outermost layer of the laminate.

This invention relates to laminating apparatus and a laminating method.

Liquid packaging carton laminates are known comprising, by way of example, progressing inwards, i.e. towards the liquid-contacting surface of the carton, an outermost, moisture-barrier layer of, e.g., low density polyethylene (LDPE); a core layer of, e.g., paperboard; an outer tie layer; an oxygen-barrier layer of, e.g., aluminium foil or ethylene vinyl alcohol (EVOH); an inner tie layer; and an innermost moisture-barrier layer of, e.g., LDPE.

In one general method of manufacturing such laminates for use in the production of cartons which have pour spout fitments applied to the exterior thereof after the cartons have been formed, filled and sealed, at least one row of through holes is formed along a paperboard core layer which is advanced along laminating apparatus, and, at a first lamination station of the apparatus, the core layer is extrusion-coated with the outermost layer of LDPE and enters a nip between two rolls at least one of which is biased towards the other and at least one of which is a chill roll. The laminate so formed is flipped over and advanced to a second laminating station at which the oxygen barrier layer is applied to the inner surface of the core layer with the interposition of the outer tie layer and through a nip between a press roll and a chill roll. The press roll has a steel core with an elastomeric sleeve thereon, so that the elastomeric sleeve urges the portions of the barrier layer and the tie layer covering the through holes in the core layer to protrude into the holes and the tie layer to adhere to the portions of the outermost layer of LDPE under the holes. At a subsequent laminating station of the apparatus the inner tie layer and the innermost layer of LDPE are co-extrusion-coated onto the laminate so formed. An example of such a press roll is disclosed in EP1345756B1, where the sleeve consists of a resilient inner layer and a resilient outer layer with the inner layer being thicker and harder than the outer layer.

According to one aspect of the present invention, there is provided a laminating station comprising a first roll, a second roll parallel to said first roll, a biasing arrangement for relatively biasing the first and second rolls together, a depositing arrangement which serves to deposit a layer at one side of a substrate prior to said substrate and said layer entering a nip between said first and second rolls, a belt-guiding arrangement extending parallelly to said first roll, leftmost and rightmost endless belts extending over said first roll and said belt guiding arrangement and through said nip, and, between said leftmost and rightmost endless belts, at least one intermediate endless belt extending over said first roll and said belt guiding arrangement and through said nip.

The laminating station may be one laminating station, or each of a plurality of laminating stations at which a molten curtain of particularly thermoplastics is deposited to one side of a single web of material or to between two webs of material.

At any lamination station at which one or more intermediate belts is not employed, a press roll of a suitable character, such as having a resilient cover with a particular outermost layer, can be employed.

The number of laminating stations will, of course, generally depend upon the number of extrusion lamination stages required to produce the desired laminate end product.

The intermediate belt(s) can be employed in the or each station to urge a substrate in the form of a core web or a laminate away from the first roll to deter adhesion of the material of the extrusion coating to the first roll and/or to press portions of a layer into holes in the substrate.

According to a second aspect of the present invention, there is provided a laminating station comprising a press roll, a second roll parallel to said press roll, a biasing arrangement for relatively biasing said press roll and said second roll together, a depositing arrangement which serves to deposit a layer upon a substrate prior to said substrate and said layer entering a nip between said press roll and said second roll, which substrate is formed with at least one row of holes distributed therealong and which holes are covered by said layer, a belt-guiding arrangement extending parallelly to said press roll, and, for the or each row of holes, an endless belt extending over said press roll and said belt-guiding arrangement.

According to a third aspect of the present invention, there is provided a laminating method comprising depositing a layer at one side of a substrate prior to said substrate and said layer entering a nip between a first roll and a second roll, and urging said substrate and said layer away from said first roll by means of a leftmost, a rightmost and at least one intermediate, endless belt, the or each belt extending over said first roll and a belt-guiding arrangement and through said nip.

According to a fourth aspect of the present invention, there is provided a laminating method comprising providing a substrate formed with at least one row of holes distributed therealong, depositing a layer upon said substrate prior to said substrate and said layer entering a nip between a press roll and a second roll, and squeezing said substrate and said layer together at the regions of said holes by means of, for the or each row of holes, an endless belt extending over said press roll and through said nip.

Owing to the invention, it is possible to reduce the tendency for material of thermoplastics coating to adhere to a roll over which a substrate and the coating are passed and/or to promote protrusion of portions of a layer into holes in a substrate. The use of belts has the advantage that they can readily be replaced by belts of different properties, for example thickness, width and hardness, to suit different depths and widths of the holes and different material properties of the various layers of the laminate.

Advantageously, the press roll comprises a rigid core with a co-axial, tubular, resilient cover.

According to a fifth aspect of the present invention, there is provided a press roll comprising a rigid core and an elastic cover on said core and co-axial therewith, said elastic cover comprising a non-adhesive outer surface.

In order that the invention may be clearly and completely disclosed, reference will now be made, by way of example, to the accompanying drawings, in which:

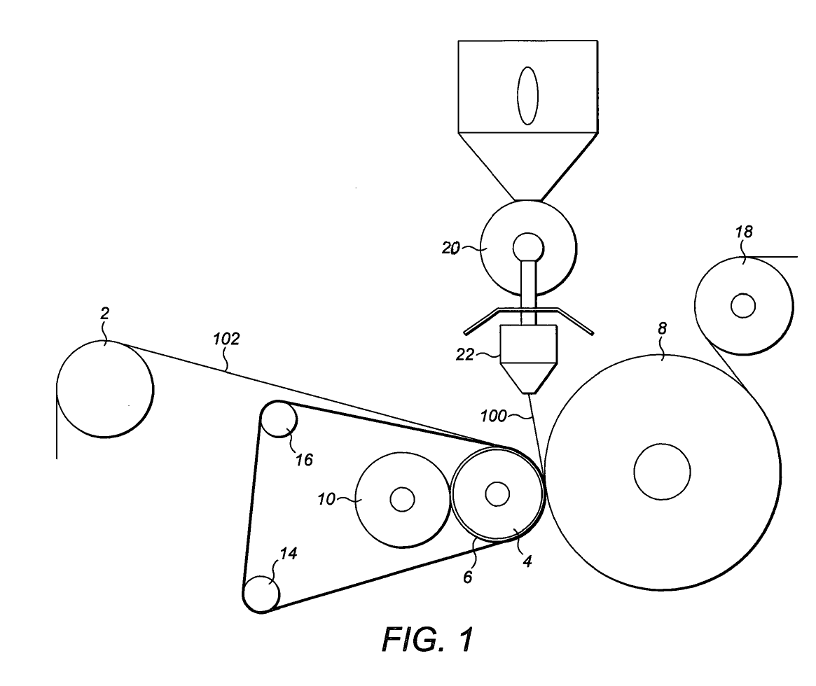

FIG. 1 is a fragmentary side elevation of a per se known laminating apparatus;

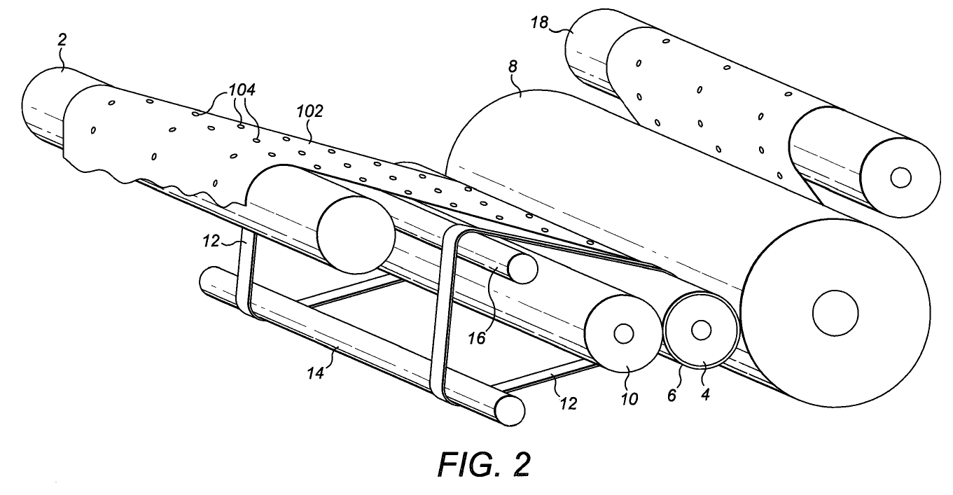

FIG. 2 is a fragmentary, diagrammatic perspective view from above of the per se known laminating apparatus; and

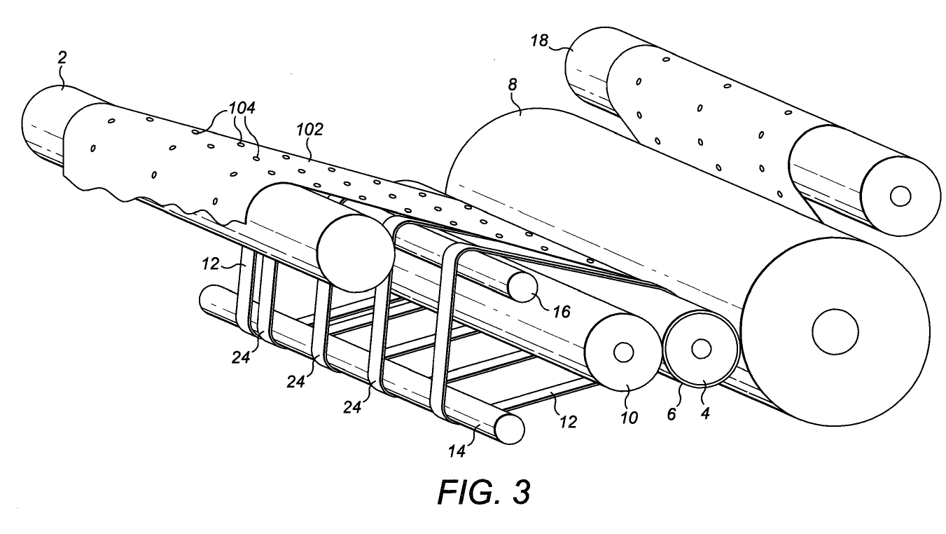

FIG. 3 is a view similar to FIG. 2 of either of two embodiments of the invention.

Referring to FIGS. 1 and 2, the apparatus includes a guide roll 2 and a press roll 4 with an elastomeric covering sleeve 6, a chill roll 8 and a back-up roll 10 which controls the width of and pressure in the nip between the rolls 4 and 8. Rightmost and leftmost belts 12 extend over tensioning and idling rollers 14 and 16 and through that nip. Downstream of the roll 8 is a roll 18. Seen in FIG. 1 but omitted from FIG. 2 for the sake of clarity is an extruder 20 feeding a die 22 from which flows a curtain 100 of thermoplastics, e.g. LDPE, to coat an advancing substrate 102. The stage shown can be an upstream one where an outermost LDPE layer (100) is applied by extrusion coating to the substrate 102 in the form of a paperboard core layer, or a downstream one where the laminate substrate so formed has been flipped over and carries at its upper surface an aluminium foil layer attached by a tie layer to the paperboard. The leftmost and rightmost belts 12 have the effect of deterring the edges of the layer 100 squeezed in the nip between the rolls 4 and 8 from contacting and adhering to the elastomeric sleeve 6. In a per se known system, the substrate 102 has been formed with rows of through holes 104 distributed therealong to constitute holes openable by manipulation of pour spout fitments following the per se known forming of cartons (from flat carton sleeves, or a reeled web, supplied to a liquid packaging form-fill-seal machine).

Referring to FIG. 3, where again the extruder 20, the die 22 and the curtain 100 have been omitted for the sake of clarity, at least one, in this case three, intermediate belts 24 are arranged between and parallel to the belts 12. The belts 24 are in the planes of the respective rows of holes 104 and deter the thermoplastics of the layer (100) from passing through the holes 104 and thus from contacting and adhering to the elastomeric materials of the sleeve 6. If the station in question is not that upstream one but is the downstream station where an innermost extrusion coating is applied to the outside of an advancing web comprised of outermost thermoplastic layer/paperboard layer/tie layer/aluminium foil, the intermediate belts (24) again extend in the same planes of the respective rows of holes 104, but perform the function of pressing the outermost LDPE layer against the tie layer backed-up by the aluminium foil and the innermost LDPE layer and thus promoting adhesion between the tie layer and the outermost LDPE layer.

In a particular example of production of a packaging laminate end product in which, progressing inwards, there are an outermost moisture-barrier layer of LPDE; paperboard; an outer tie layer; an aluminum foil oxygen barrier layer; an inner tie layer; and a innermost moisture-barrier layer of LDPE, there are three lamination stations. At the first the outermost LDPE layer is extrusion coated to the paperboard. At the second that web, flipped over, is merged with a web consisting of the outer tie layer and the aluminum foil. At a third the latter web, with the aluminum foil uppermost, a co-extrusion coating consisting of the inner tie layer and the outermost layer of LDPE is applied to the foil.

The first station is according to FIGS. 1 and 2, i.e. intermediate belts, are not employed, but instead a press roll 4 having a covering sleeve 6 comprised of rubber and an outermost layer 6. The layer 6 is non-adhesive, for example of “TEFLON”®, namely polytetrafluoroethylene (PTFE). The second station is also according to FIGS. 1 and 2, with a press roll 4 having a covering sleeve 6 comprised of rubber and an outermost layer of “TEFLON”®. The third station is according to FIG. 3. Thus adhesion between the outer tie layer and the outermost layer is promoted.

1. A laminating station comprising:
a first roll,
a second roll parallel to said first roll,
a biasing arrangement for relatively biasing the first and second rolls together,
a depositing arrangement which serves to deposit a layer at one side of a substrate prior to said substrate and said layer entering a nip between said first and second rolls,
a belt-guiding arrangement extending parallelly to said first roll, leftmost and rightmost endless belts extending over said first roll and said belt guiding arrangement and through said nip, and,
between said leftmost and rightmost endless belts, at least one intermediate endless belt extending over said first roll and said belt guiding arrangement and through said nip.

2. A laminating station according to claim 1, wherein said substrate is formed with at least one row of holes distributed therealong and for covering by said layer at one side of said substrate and by a gas barrier layer at the opposite side of the substrate, said at least one intermediate endless belt being allocated to said at least one row of holes.

3. A laminating station comprising:
a press roll,
a second roll parallel to said press roll,
a biasing arrangement for relatively biasing said press roll and said second roll together,
a depositing arrangement which serves to deposit a layer upon a substrate prior to said substrate and said layer entering a nip between said press roll and said second roll, which substrate is formed with at least one row of holes distributed therealong and which holes are covered by said layer,
a belt-guiding arrangement extending parallelly to said press roll, and,
for the or each row of holes, an endless belt extending over said press roll and said belt-guiding arrangement.

4. A laminating method comprising:
depositing a layer at one side of a substrate prior to said substrate and said layer entering a nip between a first roll and a second roll, and
urging said substrate and said layer away from said first roll by means of a leftmost, a rightmost and at least one intermediate, endless belt, the or each belt extending over said first roll and a belt-guiding arrangement and through said nip.

5. A laminating method comprising:
providing a substrate formed with at least one row of holes distributed therealong,
depositing a layer upon said substrate prior to said substrate and said layer entering a nip between a press roll and a second roll, and
squeezing said web and said layer together at the regions of said holes by means of, for the or each row of holes, an endless belt extending over said press roll and through said nip.

6. A method according to claim 5, wherein said press roll comprises a rigid core and a resilient covering sleeve on said core and co-axial therewith.

7. A method according to claim 4, wherein said substrate comprises a layer of paperboard.

8. A method according to claim 4, wherein said substrate comprises, progressing inwardly therethrough, a moisture barrier layer, a core layer, a tie layer and an oxygen barrier layer.

9. A press roll comprising a rigid core and an elastic cover on said core and co-axial therewith, said elastic cover comprising a non-adhesive outer surface.

10. A press roll according to claim 9, wherein said surface comprises polytetrafluoroethylene.

11. A station according to claim 1, wherein said press roll comprises a rigid core and a resilient covering sleeve on said core and co-axial therewith.

12. A station according to claim 2, wherein said press roll comprises a rigid core and a resilient covering sleeve on said core and co-axial therewith.

13. A station according to claim 3, wherein said press roll comprises a rigid core and a resilient covering sleeve on said core and co-axial therewith.

14. A method according to claim 5, wherein said substrate comprises a layer of paperboard.

15. A method according to claim 6, wherein said substrate comprises a layer of paperboard.

16. A station according to claim 1, wherein said substrate comprises a layer of paperboard.

17. A station according to claim 3, wherein said substrate comprises a layer of paperboard.

18. A station according claim 1, wherein said substrate comprises, progressing inwardly therethrough, a moisture barrier layer, a core layer, a tie layer and an oxygen barrier layer.

19. A station according to claim 3, wherein said substrate comprises, progressing inwardly therethrough, a moisture barrier layer, a core layer, a tie layer and an oxygen barrier layer.

20. A method according to claim 5, wherein said substrate comprises, progressing inwardly therethrough, a moisture barrier layer, a core layer, a tie layer and an oxygen barrier layer.
